(19) United States
(12) Patent Application Publication
(10) Pub. No.: US 2015/0299985 A1
(43) Pub. Date: Oct. 22, 2015

(54) HYBRID WORK MACHINE

(71) Applicant: KOMATSU LTD., Minato-ku, Tokyo (JP)

(72) Inventors: Kazuki TAKEHARA, Hiratsuka-shi (JP); Hiroaki TAKEHARA, Hiratsuka-shi (JP); Tomotaka IMAI, Hiratsuka-shi (JP)

(73) Assignee: KOMATSU LTD., Tokyo (JP)

(21) Appl. No.: 14/650,394

(22) PCT Filed: Jul. 24, 2013
(86) PCT No.: PCT/JP2013/070114

§ 371 Date: Jun. 8, 2015

(51) Int. Cl. E02F 9/20; B60W 20/00

(52) U.S. Cl. CPC E02F 9/2075; B60W 20/10; Y10S 903/904

(57) ABSTRACT

A hybrid work machine includes: an engine; a generator motor connected to an output shaft of the engine; a storage battery configured to store power generated by the generator motor and supply power to the generator motor; a motor configured to be driven by at least one of power generated by the generator motor and power stored in the storage battery; a transformer disposed between the storage battery and both the generator motor and the motor; and a control unit configured to stop the transformer at a time of satisfying a plurality of conditions including a condition that the engine is in an idling state and a condition that a motor driving command to drive the motor is not output.

### FIELD

The present invention relates to a hybrid work machine capable of improving fuel consumption by stopping a transformer during an idling state without giving a sense of discomfort to operation of an operator.

### BACKGROUND

There is a hybrid work machine configured to operate a work unit or the like by driving a generator motor with an engine and driving a motor with power generated by the generator motor. For example, Patent Literature 1 discloses a technology in which a hydraulic pump and a generator motor are driven by an engine, and a battery is charged by power generation action of the generator motor, and further a swing motor is driven by the battery power, thereby swinging an upper swing body on which a work unit is mounted. Note that the work unit is driven by hydraulic oil supplied from the hydraulic pump, and a lower traveling body is driven by a hydraulic motor driven by the hydraulic pump. Further, according to this Patent Literature 1, a parking brake configured to stop and hold the upper swing body is released on the condition that cylinder thrust of the work unit reaches to a setting value or higher, and also the upper swing body is stopped and held by executing speed feedback control or position feedback control for the swing motor.

Additionally, Patent Literature 2 discloses a technology related to a hybrid vehicle inverter system is in which efficiency of an entire inverter is improved by stopping boosting operation at a step-up/step-down chopper circuit during the idling state, and reducing loss at a semiconductor device in the step-up/step-down chopper circuit.

### CITATION LIST

### Patent Literature

Patent Literature 1: Japanese Laid-open Patent Publication No. 2005-299102

Patent Literature 2: Japanese Laid-open Patent Publication No. 2002-171606

### SUMMARY

### Technical Problem

Meanwhile, a hybrid work machine configured to supply power from a capacitor via a transformer has an auto-deceleration function to shift an operating state to an idling state in which an engine speed is low in the case where operation of a work unit or travel operation is stopped for a certain period. Further, in this hybrid work machine, the transformer is in a startup state even in the idling state. In the idling state, electric current is little input or output to or from the capacitor, but while the transformer is in the startup state, power is supplied to the transformer from the capacitor. Therefore, voltage at the capacitor is gradually decreased due to transform loss at the transformer and switching loss at a semiconductor device. Due to such voltage decrease at the capacitor, power is needed to be resupplied to the capacitor, and control to increase an engine speed is executed by escaping from the idling state such that the generator motor connected to the engine is caused to generate power. As a result, since the transformer is in the startup state, there may be a problem in which engine speed is increased and fuel efficiency is deteriorated even though the state is shifted to the idling state by the auto-deceleration function.

Here, it is conceivable to stop the transformer when the hybrid work machine is in an auto-deceleration state, but when the transformer is stopped only on the condition that the state is in the auto-deceleration state, the transformer may be stopped even in the case where swing operation and work unit operation are continuously executed other than the case where operation is stopped for a certain period by lever operation relative to the swing operation and work unit operation. For example, this may occur in the case where a swing motor servo command is an ON-state or in the case where a hydraulic lock switch is an OFF-state, and in these cases, an operator continues executing the swing operation and work unit operation. In the case where the transformer is stopped despite the fact that the operator has the intention to execute the operation as described above, a startup time required to start the transformer is spent against the intention of the operator who may think that the transformer is started up immediately. As a result, a sense of discomfort contrary to the operator's intention may be caused.

The present invention is made considering the above-described situation, and directed to providing a hybrid work machine capable of improving fuel consumption by stopping a transformer during an idling state without giving a sense of discomfort to operation of the operator.

### Solution to Problem

To solve the above-described problem and achieve the object, a hybrid work machine according to the present invention includes: an engine; a generator motor connected to an output shaft of the engine; a storage battery configured to store power generated by the generator motor and supply power to the generator motor; a motor configured to be driven by at least one of power generated by the generator motor and power stored in the storage battery; a transformer disposed between the storage battery and both the generator motor and the motor; and a control unit configured to stop the transformer at a time of satisfying a plurality of conditions including a condition that the engine is in an idling state and a condition that a motor driving command to drive the motor is not output.

Moreover, a hybrid work machine according to the present invention includes: an engine; a generator motor connected to an output shaft of the engine; a storage battery configured to store power generated by the generator motor and supply power to the generator motor; a motor configured to be driven by at least one of power generated by the generator motor and power stored in the storage battery; a transformer disposed between the storage battery and both the generator motor and the motor; and a control unit configured to stop the transformer at a time of satisfying a plurality of conditions including a condition that the engine is in an idling state and a condition that a hydraulic lock switch is in a lock state.

Moreover, a hybrid work machine according to the present invention includes: an engine; a generator motor connected to an output shaft of the engine; a storage battery configured to store power generated by the generator motor and supply power to the generator motor; a motor configured to be driven by at least one of power generated by the generator motor and power stored in the storage battery; a transformer disposed between the storage battery and both the generator motor and the motor; and a control unit configured to stop the transformer at a time of satisfying a plurality of conditions including a condition that the engine is in an idling state, a condition that a motor driving command to drive the motor is not output, and a condition that a hydraulic lock switch is in a lock state.

Moreover, in the above-described hybrid work machine according to the present invention, the motor is a swing motor configured to swing a swing body, and the control unit is configured to stop the transformer in the case of satisfying a plurality of conditions added with a condition that a zero clamp is OFF.

Moreover, in the above-described hybrid work machine according to the present invention, the control unit permits start of the transformer based on a generator motor speed.

Moreover, in the above-described hybrid work machine according to the present invention, the control unit permits start of the transformer at a time of not satisfying at least of one of the plurality of conditions.

Moreover, in the above-described hybrid work machine according to the present invention, the control unit stops the transformer by cutting off energization to the transformer while a contactor configured to execute connection and disconnection between the storage battery and the transformer is kept connected.

According to the present invention, the transformer is stopped in the case of satisfying a plurality of conditions including a condition that an engine is in an idling state and a condition that a motor driving command to drive a motor is not output. In the case of returning the transformer from stopped state to the startup state, the transformer can be started only by at least one of the above-described conditions being negated. Therefore, fuel consumption can be improved by stopping the transformer during the idling state without giving a sense of discomfort to operation of the operator.

### BRIEF DESCRIPTION OF DRAWINGS

FIG. 1 is a perspective view illustrating a hybrid excavator as an example of a hybrid work machine.

FIG. 2 is a block diagram illustrating a device configuration of the hybrid excavator illustrated in FIG. 1.

FIG. 3 is a circuit diagram illustrating a detailed configuration of a transformer.

FIG. 4 is a block diagram illustrating a control configuration to stop/start the transformer by a hybrid controller.

FIG. 5 is a state transition diagram in controlling stop/start of the transformer by the hybrid controller.

FIG. 6 is a diagram illustrating a detailed configuration of a transformer stop flag determining unit during deceleration.

FIG. 7 is a flowchart illustrating detailed processing of a transformer start permission flag determining unit.

FIG. 8 is a diagram illustrating determining processing in an auto-deceleration state illustrated in FIG. 6.

FIG. 9 is a diagram illustrating determining processing of a pump controller in the auto-deceleration state illustrated in FIG. 8.

FIG. 10 is a diagram illustrating the determining processing in an auto-deceleration enable state of a hybrid system illustrated in FIG. 8.

### DESCRIPTION OF EMBODIMENTS

In the following, embodiments to implement the present invention will be described with reference to the attached drawings.

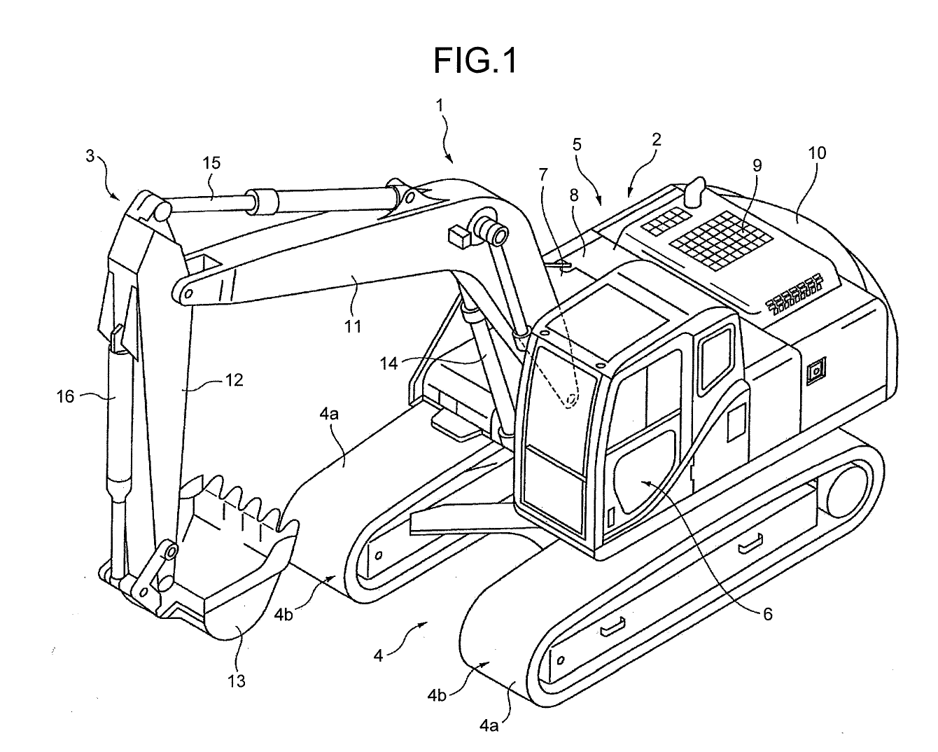

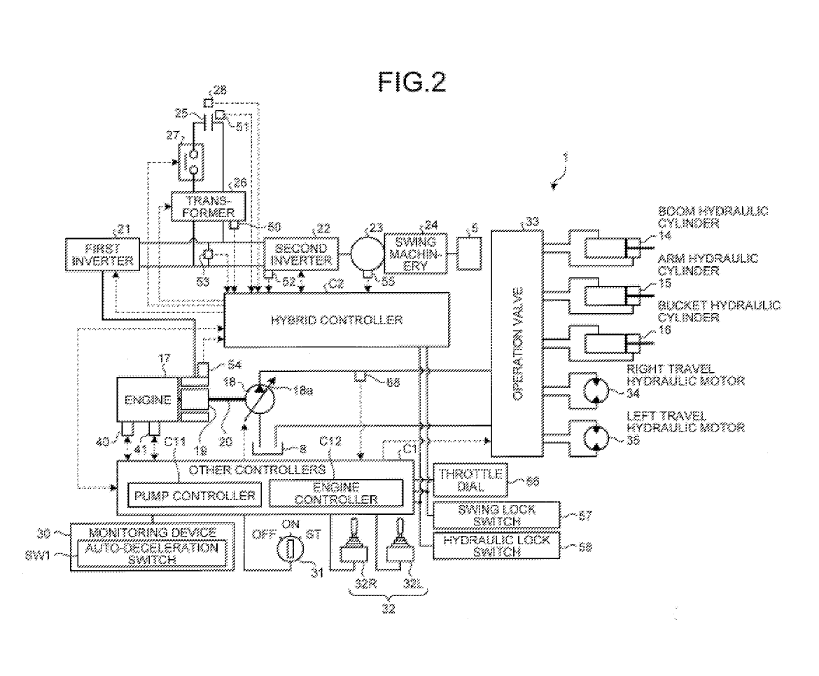

FIG. 1 is a perspective view illustrating a hybrid excavator 1 as an example of a hybrid work machine. FIG. 2 is a block diagram illustrating a device configuration of the hybrid excavator 1 illustrated in FIG. 1. Note that a concept of a pure work machine, which is not hybrid, includes construction machines such as an excavator, a bulldozer, a dump truck, and a wheel loader, and it is defined here that a hybrid work machine has a configuration unique to hybrid, in which an electric motor configured to be driven by drive force from an engine as well as power exchanged with other power supply devices is included in the above-described construction machines.

(Hybrid Excavator)

The hybrid excavator 1 includes a vehicle body 2, and a work unit 3. The vehicle body 2 includes a lower traveling body 4, and an upper swing body 5. The lower traveling body 4 includes a pair of travel devices 4a. The respective travel devices 4a include crawlers 4b. The respective travel devices 4a make the hybrid excavator 1 travel by driving the crawlers 4b by rotationally driving a right travel hydraulic motor 34 and a left travel hydraulic motor 35 illustrated in FIG. 2.

The upper swing body 5 is provided at an upper portion of the lower traveling body 4 in a swingable manner. The upper swing body 5 includes a swing motor 23 in order to swing itself. The swing motor 23 is connected to a drive shaft of a swing machinery 24 (reducer). Rotative force of the swing motor 23 is transmitted via the swing machinery 24, the transmitted rotative force is transmitted to the upper swing body 5 via a swing pinion, a swing circle, etc. not illustrated, and swings the upper swing body 5. The swing motor in the present embodiment is electrically driven. Note that the swing motor may also be driven by combining an electric motor and a hydraulic motor. Further, an electric actuator driven by the electric motor may drive not only the upper swing body but also a hydraulic pump or the like configured to drive the work unit.

An operating room 6 is provided at the upper swing body 5. Further, the upper swing body 5 includes a fuel tank 7, a hydraulic oil tank 8, an engine room 9, and a counterweight 10. The fuel tank 7 stores fuel to drive an engine 17 as an internal-combustion engine. The hydraulic oil tank 8 stores hydraulic oil to be discharged from a hydraulic pump 18 to hydraulic devices including: hydraulic cylinders such as a boom hydraulic cylinder 14, an arm hydraulic cylinder 15, and a bucket hydraulic cylinder 16; and the hydraulic motors (hydraulic actuators) such as the right travel hydraulic motor 34 and left travel hydraulic motor 35. In the engine room 9, various kinds of devices such as the engine 17, the hydraulic pump 18, a generator motor 19, and a capacitor 25 as a storage battery are housed. The counterweight 10 is disposed behind the engine room 9.

The work unit 3 is mounted at a center position of a front portion of the upper swing body 5, and includes a boom 11, an arm 12, a bucket 13, the boom hydraulic cylinder 14, the arm hydraulic cylinder 15, and the bucket hydraulic cylinder 16. A base end portion of the boom 11 is connected to the upper swing body 5 in a swingable manner. Further, a tip portion of the boom 11 on an opposite side of the base end portion is connected to a base end portion of the arm 12. The bucket 13 is rotatably connected to a tip portion of the arm 12 on an opposite side of the base end portion. Further, the bucket 13 is connected to the bucket hydraulic cylinder 16 via a link. The boom hydraulic cylinder 14, arm hydraulic cylinder 15, and bucket hydraulic cylinder 16 are the hydraulic cylinders (hydraulic actuators) configured to extend and contract by hydraulic oil discharged from the hydraulic pump 18. The boom hydraulic cylinder 14 swings the boom 11. The arm hydraulic cylinder 15 swings the arm 12. The bucket hydraulic cylinder 16 swings the bucket 13.

In FIG. 2, the hybrid excavator 1 includes the engine 17, the hydraulic pump 18, and the generator motor 19 as driving sources. A diesel engine is used as the engine 17, and a variable displacement hydraulic pump is used as the hydraulic pump 18. The hydraulic pump 18 is, for example, a swash plate hydraulic pump in which pump capacity is changed by changing an inclination angle of a swash plate 18a, but the hydraulic pump is not limited thereto. In the engine 17, a rotation sensor 41 configured to detect a rotation speed of the engine 17 (engine speed per unit time) is provided. A signal indicating the rotation speed of the engine 17 (engine speed) detected by the rotation sensor 41 is acquired by an engine controller C12, and received in a hybrid controller C2 from the engine controller C12 via an in-vehicle network. The rotation sensor 41 detects the engine speed of the engine 17.

A drive shaft 20 of the engine 17 is mechanically connected to the hydraulic pump 18 and generator motor 19, and the hydraulic pump 18 and generator motor 19 are driven by drive of the engine 17. As a hydraulic drive system, an operation valve 33, the boom hydraulic cylinder 14, the arm hydraulic cylinder 15, the bucket hydraulic cylinder 16, the right travel hydraulic motor 34, the left travel hydraulic motor 35, etc. are included. The hydraulic pump 18 functions as a hydraulic oil supply source to the hydraulic drive system, and drives these hydraulic devices. A right operating lever 32R and a left operating lever 32L are provided on the right and left sides of an operator's seat as operating levers 32. Vertical movement of the boom 11, and excavation/dump operation of the bucket 13 can be executed corresponding to operation of the right operating lever 32R in front, rear, right, and left directions. The excavation/dump operation of the arm 12, and lateral swing operation of the upper swing body 5 can be executed corresponding to operation of the left operating lever 32L in front, rear, right, and left directions. Additionally, the operation valve 33 is a flow direction control valve configured to move a spool not illustrated in accordance with operating directions of the operating levers 32, and regulate a flow direction of the hydraulic oil to each of the hydraulic actuators. Further, the operation valve 33 is configured to supply the hydraulic oil to the hydraulic actuators: for example, the boom hydraulic cylinder 14, the arm hydraulic cylinder 15, and the bucket hydraulic cylinder 16 in accordance with operating amounts of the operating levers 32, and also the right travel hydraulic motor 34 or the left travel hydraulic motor 35 in accordance with operation of right and left travel levers not illustrated. Further, output of the engine 17 may be transmitted to the generator motor 19 via a PTO (Power Take Off) shaft. Note that pump pressure of the hydraulic oil discharged from the hydraulic pump 18 is detected by a pressure sensor 61, and received in other controllers C1. Note that other controllers C1 include controllers such as a pump controller C11, and the engine controller C12 other than the hybrid controller C2.

An electric driving system includes a first inverter 21 connected to the generator motor 19 via a power cable, a second inverter 22 connected to the first inverter 21 via a wiring harness, a transformer 26 provided between the first inverter 21 and the second inverter 22 via the wiring harness, a capacitor 25 connected to the transformer 26 via a contactor 27 (electromagnetic contactor), the swing motor 23 connected to the second inverter 22 via a power cable, and so on. Note that the contactor 27 normally closes an electric circuit between the capacitor 25 and the transformer 26 to form an energized state. On the other hand, the hybrid controller C2 determines necessity to open the electric circuit in accordance with detection of electricity leakage and the like. When such determination is given, a command signal to change the energized state to a cut-off state is output to the contactor 27. Further, the contactor 27 having received the command signal from the hybrid controller C2 opens the electric circuit.

The swing motor 23 is mechanically connected to the swing machinery 24 as described above. At least one of power generated by the generator motor 19 and power stored in the capacitor 25 becomes a power source of the swing motor 23, and swings the upper swing body 5 via the swing machinery 24. More specifically, the swing motor 23 accelerates swing of the upper swing body 5 by executing power running operation with the power supplied from at least one of the generator motor 19 and capacitor 25. Further, the swing motor 23 executes regenerative operation at the time of decelerating swing of the upper swing body 5, and supplies (charges) the power (regenerative energy) generated by the regenerative operation to the capacitor 25 or return shaft output to the engine 17 via the generator motor 19. Note that the swing motor 23 is provided with a rotation sensor 55 configured to detect the rotation speed of the swing motor 23 (swing motor rotation speed). The rotation sensor 55 is capable of measuring the rotation speed of the swing motor 23 at the time of power running operation (swing acceleration) or regenerative operation (swing deceleration). A signal indicating the rotation speed measured by the rotation sensor 55 is received in the hybrid controller C2. For the rotation sensor 55, a resolver can be used, for example.

The generator motor 19 supplies (charges) the generated power to the capacitor 25, and also supplies the power to the swing motor 23 depending on the situation. For the generator motor 19, SR (Switched Reluctance) motor is used, for example. Note that, in the case of using a synchronous motor using a permanent magnet instead of the SR motor, the synchronous motor can function to supply electric energy to the capacitor 25 or the swing motor 23. In the case of using the SR motor for the generator motor 19, there is advantage in terms of cost because a magnet including an expensive rare metal is not used in the SR motor. The generator motor 19 has a rotor shaft mechanically connected to the drive shaft 20 of the engine 17. With this configuration, the rotor shaft of the generator motor 19 is rotated by drive of the engine 17, thereby the generator motor 19 generating the power. Further, a rotation sensor 54 is attached to the rotor shaft of the generator motor 19. The rotation sensor 54 measures a rotation speed of the generator motor 19 (generator motor speed), and a signal indicating the generator motor speed measured by the rotation sensor 54 is received in the hybrid controller C2. For the rotation sensor 54, a resolver can be used, for example.

The transformer 26 is disposed between the capacitor 25 and both the generator motor 19 and swing motor 23. The transformer 26 optionally boosts voltage of power (electric charge stored in the capacitor 25) supplied to the generator motor 19 or the swing motor 23 via the first inverter 21 and the second inverter 22. The boosted voltage is applied to the swing motor 23 at the time of causing the swing motor 23 to execute power running operation (swing acceleration), and is applied to the generator motor 19 at the time of assisting the output of the engine 17. Note that the transformer 26 has a function to drop (step down) the voltage to ½ at the time of charging the power generated by the generator motor 19 or the swing motor 23 to the capacitor 25. A transformer temperature sensor 50 configured to detect a temperature of the transformer 26 is attached to the transformer 26. A signal indicating the transformer temperature measured by the transformer temperature sensor 50 is received in the hybrid controller C2. Further, a voltage detection sensor 53 is attached to the wiring harnesses between the transformer 26 and both the first inverter 21 and second inverter 22 in order to measure a level of voltage boosted by the transformer 26 or a level of voltage of the power generated by regeneration of the swing motor 23. A signal indicating the voltage measured by the voltage detection sensor 53 is received in the hybrid controller C2.

According to the present embodiment, the transformer 26 has functions to boost or drop input DC power, and output the same as the DC power. A type of the transformer 26 is not particularly limited as long as the above-described functions are provided. According to the present embodiment, for example, a transformer referred to as a transformer-coupled transformer in which the transformer and two inverters are combined with the transformer 26 is used. Besides this, a DC-DC converter may also be adopted for the transformer 26. Next, the transformer-coupled transformer will be briefly described.

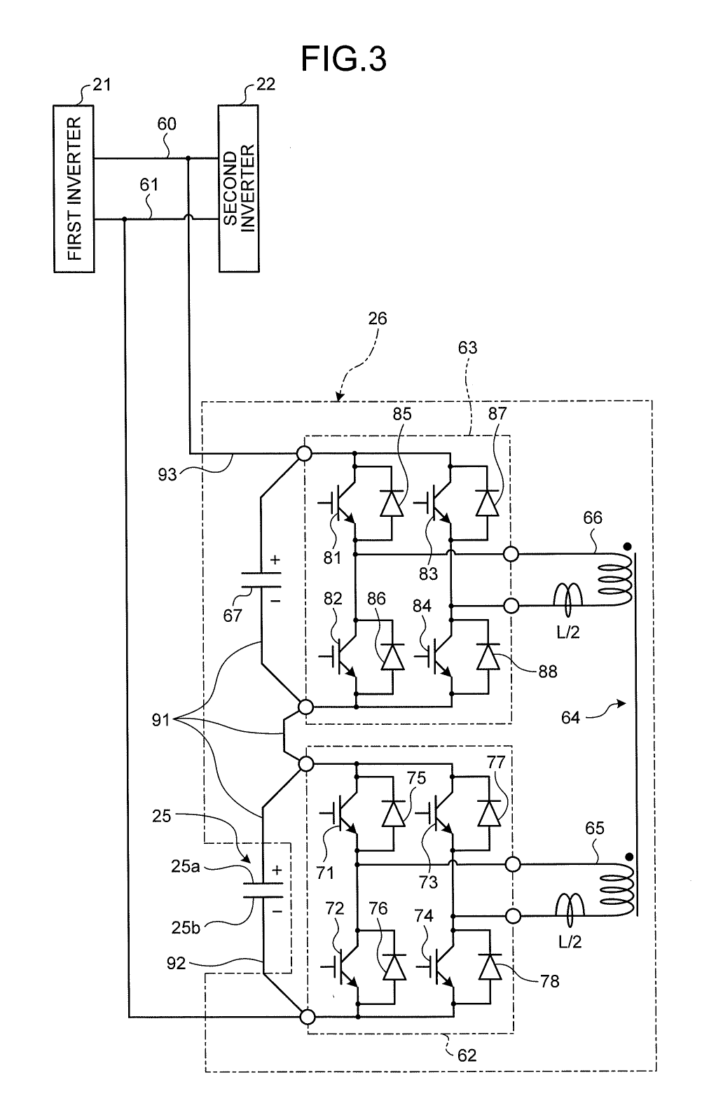

FIG. 3 is a diagram illustrating the transformer-coupled transformer as the transformer. As illustrated in FIG. 3, the first inverter 21 and the second inverter 22 are connected via a positive electrode line 60 and a negative electrode line 61. The transformer 26 is connected between the positive electrode line 60 and the negative electrode line 61. The transformer 26 adopts AC (Alternating Current) link using a transformer 64 between the two inverters: a low-pressure side inverter 62, namely, a primary side inverter with a high-pressure side inverter 63, namely, a secondary inverter. Thus, the transformer 26 is the transformer-coupled transformer. In the following description, note that a winding ratio between a low-pressure side coil 65 and a high-pressure side coil 66 of the transformer 64 is set to one-to-one. Further, the winding ratio may be optionally changed.

The low-pressure side inverter 62 and the high-pressure side inverter 63 are electrically connected in series such that a positive electrode of the low-pressure side inverter 62 and a negative electrode of the high-pressure side inverter 63 have additive polarity. In other words, the transformer 26 is connected in parallel so as to have the same polarity as the first inverter 21.

The low-pressure side inverter 62 includes: four IGBTs (Isolated Gate Bipolar Transistor) 71, 72, 73, 74 bridge-connected to the low-pressure side coil 65 of the transformer 64; and diodes 75, 76, 77, 78 connected in parallel to the IGBTs 71, 72, 73, 74 respectively and having polarities in opposite directions. The bridge connection referred here represents a configuration in which the low-pressure side coil 65 has an end connected to an emitter of the IGBT 71 and a collector of the IGBT 72, and the other end connected to an emitter of the IGBT 73 and a collector of the IGBT 74. The IGBTs 71, 72, 73, 74 are turned on by switching signals being applied to gates, and current flows from the collectors to the emitters.

A positive electrode terminal 25a of the capacitor 25 is electrically connected to a collector of the IGBT 71 via a positive electrode line 91. The emitter of the IGBT 71 is electrically connected to the collector of the IGBT 72. The emitter of the IGBT 72 is electrically connected to a negative electrode terminal 25b of the capacitor 25 via a negative electrode line 92. The negative electrode line 92 is connected to the negative electrode line 61.

In the same manner, the positive electrode terminal 25a of the capacitor 25 is electrically connected to the collector of the IGBT 73 via the positive electrode line 91. The emitter of the IGBT 73 is electrically connected to the collector of the IGBT 74. The emitter of the IGBT 74 is electrically connected to the negative electrode terminal 25b of the capacitor 25 via the negative electrode line 92.

The emitter of the IGBT 71 (anode of diode 75) and the collector of the IGBT 72 (cathode of diode 76) are connected to one terminal of the low-pressure side coil 65 of the transformer 64, and also the emitter of the IGBT 73 (anode of diode 77) and the collector of the IGBT 74 (cathode of diode 78) are connected to the other terminal of the low-pressure side coil 65 of the transformer 64.

The high-pressure side inverter 63 includes: four IGBTs 81, 82, 83, 84 bridge-connected to the high-pressure side coil 66 of the transformer 64; and diodes 85, 86, 87, 88 connected in parallel to the IGBTs 81, 82, 83, 84 respectively and having polarities in opposite directions. The bridge connection referred here represents a configuration in which the high-pressure side coil 66 has an end connected to an emitter of the IGBT 81 and a collector of the IGBT 82, and the other end connected to an emitter of the IGBT 83 and a collector of the IGBT 84. The IGBTs 81, 82, 83, 84 are turned on by switching signals being applied to gates, and current flows from the collectors to the emitters.

The collectors of IGBTs 81, 83 are electrically connected to the positive electrode line 60 of the first inverter 21 via a positive electrode line 93. The emitter of the IGBT 81 is electrically connected to the collector of the IGBT 82. The emitter of the IGBT 83 is electrically connected to the collector of the IGBT 84. The emitters of the IGBTs 82, 84 are electrically connected to the positive electrode line 91, namely, the collectors of the IGBTs 71, 73 of the low-pressure side inverter 62.

The emitter of the IGBT 81 (anode of diode 85) and the collector of the IGBT 82 (cathode of diode 86) are electrically connected to one terminal of the high-pressure side coil 66 of the transformer 64, and also the emitter of the IGBT 83 (collector of diode 87) and the collector of the IGBT 84 (cathode of diode 88) are electrically connected to the other terminal of the high-pressure side coil 66 of the transformer 64.

A capacitor 67 is electrically connected between the positive electrode line 93 connected to the collectors of the IGBTs 81, 83 and the positive electrode line 91 connected to the emitters of the IGBTs 82, 84. The capacitor 67 is used to absorb ripple current. The capacitor 67 used to absorb the ripple current may be connected to the collector side of the IGBT 71 and the emitter side of the IGBT 72.

The transformer 64 has a leakage inductance having a constant value L. The leakage inductance can be obtained by adjusting a gap between the low-pressure side coil 65 and the high-pressure side coil 66 of the transformer 64. In FIG. 3, the leakage inductance is divided such that the inductance value on the low-pressure side coil 65 becomes L/2 and that on the high-pressure side coil 66 becomes L/2.

The above-described transformer temperature sensor 50 is attached to each of the low-pressure side coil 65 and the high-pressure side coil 66 included in the transformer 64, and also attached to each of the IGBTs 71, 72, 73, 74 of the low-pressure side inverter 62 and each of the IGBTs 81, 82, 83, 84 of the high-pressure side inverter 63.

Current at the generator motor 19 and the swing motor 23 is respectively controlled by the first inverter 21 and the second inverter 22 under control of the hybrid controller C2. An ammeter 52 is provided at the second inverter 22 in order to measure magnitude of direct current input to the second inverter 22. A value of the current flowing in the second inverter 22 may be also calculated without using the ammeter based on a speed and a command torque value of the swing motor 23 and estimated conversion efficiency at the inverter. A signal indicating the current detected by the ammeter 52 is received in the hybrid controller C2. An amount of power accumulated in the capacitor 25 (charge amount or electrical capacitance) can be controlled using the voltage level as an index. A voltage sensor 28 is provided at a predetermined output terminal of the capacitor 25 in order to detect the voltage level of the power accumulated in the capacitor 25. A signal indicating the voltage of the capacitor detected by the voltage sensor 28 is received in the hybrid controller C2. The hybrid controller C2 monitors the charge amount (power amount (charge amount or electrical capacitance)) of the capacitor 25, and performs energy management such as supplying (charging) the power generated by the generator motor 19 to the capacitor 25 or supplying to the swing motor 23 (power supply for power running action).

According to the present embodiment, an electric double-layered capacitor is used for the capacitor 25, for example. Instead of the capacitor 25, a storage battery configured to function as another secondary battery, such as a lithium-ion cell and nickel-hydrogen cell, may also be used. Further, a permanent magnet synchronous motor is used for the swing motor 23, for example, but not limited thereto. A capacitor temperature sensor 51 configured to detect a temperature of the capacitor 25 as the storage battery is attached to the capacitor 25. A signal indicating the capacitor temperature measured by the capacitor temperature sensor 51 is received in the hybrid controller C2.

The hydraulic driving system and the electric driving system are driven in response to operation of the operating levers 32 such as a work unit lever and a swing lever provided inside the operating room 6 disposed at the vehicle body 2. As described above, vertical movement of the boom 11 and excavation/dump operation of the bucket 13 are executed in response to operation of the right operating lever 32R in the front, rear, right, and left directions, and lateral swing operation and the excavation/dump operation of the arm 12 are executed in response to operation of the left operating lever 32L in the front, rear, right, and left directions. The right and left travel levers not illustrated are provided in addition to the above-described levers. In the case where an operator of the hybrid excavator 1 operates the left operating lever 32L (swing lever) as an operating unit to swing the upper swing body 5, an operating direction and an operating amount of the swing lever are detected by a potentiometer, a pilot pressure sensor, or the like, and the detected operating amount is transmitted to other controllers C1 and also to the hybrid controller C2 as an electric signal.

In the case where the other operating lever 32 is operated, an electric signal is also transmitted to other controllers C1 and the hybrid controller C2 in the same manner. The hybrid controller C2 controls the second inverter 22, the transformer 26, and the first inverter 21 in accordance with the operating direction and the operating amount of the swing lever or the operating direction and the operating amount of the other operating lever 32 in order to execute power transfer control (energy management) such as rotary operation of the swing motor 23 (power running action and regenerative action), electric energy management for the capacitor 25 (control for charge or discharge), and electric energy management for the generator motor 19 (assist for power generation or engine output, and power running action to the swing motor 23).

A monitoring device 30 and a key switch 31 are provided inside the operating room 6 in addition to the operating levers 32. The monitoring device 30 is formed of a liquid crystal panel, an operating button, and so on. Further, the monitoring device 30 may be a touch panel in which a display function of the liquid crystal panel and a function of inputting various kinds of information with the operating button are integrated. The monitoring device 30 is an information input/output device having a function to notify an operator or a service man of information indicating operational states of the hybrid excavator 1 (state of engine water temperature, state of occurrence of failure in hydraulic devices, etc. or state of residual fuel amount, and so on), and further a function for an operator to execute desired setting or command issuance (setting for engine output level, setting for speed level of travel speed, etc. or command for capacitor charge releasing described later) with respect to the hybrid excavator 1. For example, the monitoring device 30 includes an auto-deceleration switch SW1 to set an auto-deceleration function. Note that the auto-deceleration function is used to improve fuel consumption by shifting the engine speed to an idling state in the case of stopping the work unit for a predetermined period.

A throttle dial 56 is a switch to set a fuel supply amount to the engine 17, and a setting value of the throttle dial 56 is converted to an electric signal and output to other controllers C1.

A swing lock switch 57 is a switch to lock the upper swing body 5 with a lock pin or the like. Further, a PPC lock lever not illustrated configured to cut off supply of pilot hydraulic adapted to drive the work unit 3 is provided. The PPC lock lever includes a hydraulic lock switch 58. When the PPC lock lever is operated to a lock state, the hydraulic lock switch 58 actuates together and transmits, to the hybrid controller C2 and the pump controller C11, a signal indicating the lock state of the operation from the work unit lever.

The key switch 31 includes a key cylinder as a main component. The key switch 31 is configured to start a starter (engine start motor) attached to the engine 17 and drive the engine (engine start) by inserting a key into the key cylinder and turning the key. Further, the key switch 31 is configured to issue a command to stop the engine (engine stop) by turning the key in an opposite direction of the engine start while driving the engine. In other words, the key switch 31 is a command output unit configured to output the command to the engine 17 and various kinds of electric devices of the hybrid excavator 1.

When the key is turned to stop the engine 17 (more specifically, turned to an OFF position described later), fuel supply to the engine 17 and power supply (energization) to the various kinds of electric devices from a battery not illustrated are cut off, thereby stopping the engine. When the key is turned to the OFF position, the key switch 31 cuts off energization to the various kinds of electric devices from the battery not illustrated, and when the key is turned to an ON position, the key switch energizes the various kinds of electric devices from the battery not illustrated. Further, when the key is turned from the ON position to a START (ST) position, the engine can be started by starting the starter not illustrated. After the engine 17 is started, the key is kept turned to the ON position while the engine 17 is driven.

Note that a different command output unit such as a push button type key switch may be adopted instead of the key switch 31 in which the above-described key cylinder is the main component. More specifically, a button may have functions to change a state to ON when the button is pushed once while the engine 17 is stopped, and change the state to START (ST) when the button is pushed again, and further change the state to OFF when the button is pushed while the engine 17 is driven. Further, on the condition that the button is pushed for a predetermined time while the engine 17 is stopped, the state may be changed from OFF to START (ST) such that the engine 17 can be started.

The other controllers C1 control the engine 17 and the hydraulic pump 18 based on a command signal output from the monitoring device 30, a command signal output in response to the key position of the key switch 31, and a command signal output in response to operation of the operating levers 32 (signal indicating the above-described operating amount and operating direction). The engine 17 is mainly controlled by the engine controller C12 inside the other controllers C1. Further, the hydraulic pump 18 is mainly controlled by the pump controller C11 inside the other controllers C1. The engine 17 is an engine capable of executing electrical control with a common-rail fuel injector 40. The engine 17 can obtain target engine output by appropriately controlling a fuel injection amount with the other controllers C1, and driving can be executed by setting an engine speed and torque that can be output in accordance with a load state of the hybrid excavator 1.

The hybrid controller C2 controls the power transfer with the generator motor 19, the swing motor 23, and the capacitor 25 by controlling the first inverter 21, the second inverter 22, and the transformer 26 under coordination control with the other controllers C1 as described above. Further, the hybrid excavator 1 includes a function to stop the transformer, and the hybrid controller C2 stops the transformer 26 at the time of deceleration, and also controls permission to start the transformer 26.

(Controlling Stop/Start of Transformer)

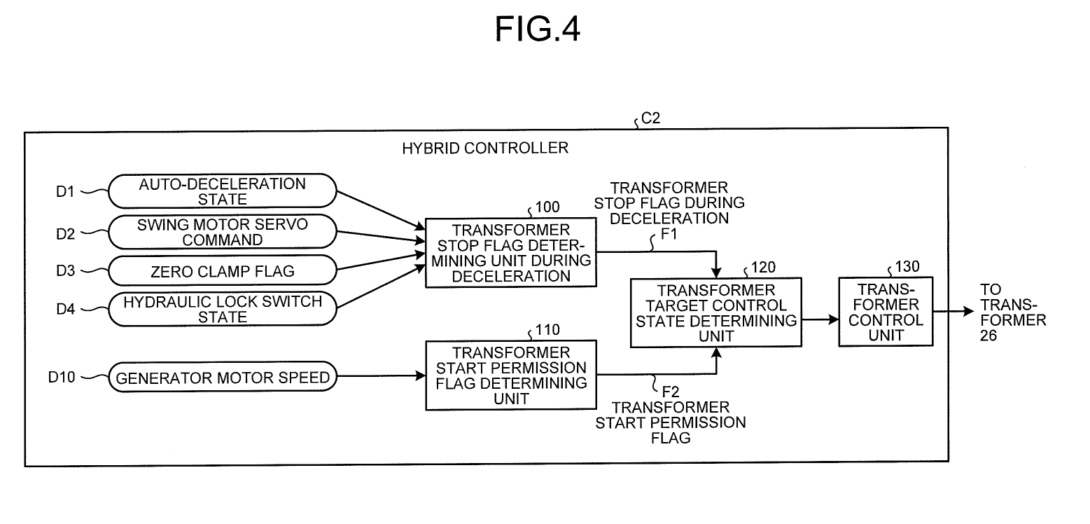

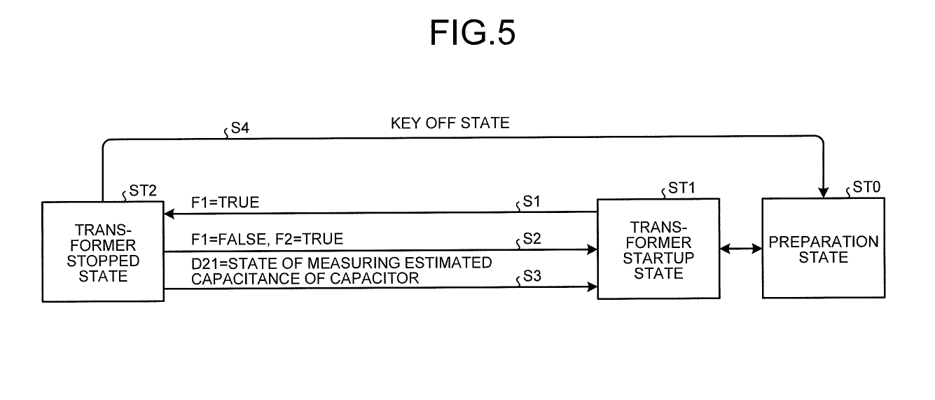

Here, referring to FIGS. 4 and 5, an overview of controlling stop of the transformer 26 during deceleration and controlling start of the transformer 26 by the hybrid controller C2 will be described. FIG. 4 is a block diagram illustrating a control configuration to stop/start the transformer by the hybrid controller C2. Further, FIG. 5 is a state transition diagram in controlling stop/start of the transformer by the hybrid controller C2.

As illustrated in FIG. 4, the hybrid controller C2 includes a transformer stop flag determining unit during deceleration 100, a transformer start permission flag determining unit 110, a transformer target control state determining unit 120, and a transformer control unit 130. Note that an auto-deceleration state D1, a swing motor servo command D2, a zero clamp flag D3, a hydraulic lock switch state D4, and a generator motor speed D10 are received in the hybrid controller C2. Further, the control state of the transformer 26 by the transformer control unit 130 is fed back to the transformer stop flag determining unit during deceleration 100, the transformer start permission flag determining unit 110, and the transformer target control state determining unit 120 depending on necessity.

The transformer stop flag determining unit during deceleration 100 sets, to TRUE, a transformer stop flag during deceleration F1 configured to stop the transformer 26, and outputs the same to the transformer target control state determining unit 120 in the case where the transformer 26 is in a transformer startup state ST1 or a transformer stopped state ST2, the auto-deceleration state D1 is an auto-deceleration (TRUE), the swing motor servo command D2 is OFF, the zero clamp flag D3 is OFF, and the hydraulic lock switch state D4 is a lock state. Note that zero clamp is to keep a present position of the upper swing body 5 in accordance with a position control command so as not to be swung by the swing motor 23, and also to make a state same as swing lock by supplying power to the swing motor 23. Further, when the swing motor servo command D2 is OFF, it indicates a state in which a swing command is not output to the swing motor 23 and a servo command is not output to the swing motor 23 from the second inverter 22, determining that the operator has no intention to execute operation based on a fact that the lever to drive the swing motor 23 is not operated.

The transformer start permission flag determining unit 110 changes the transformer start permission flag F2 to TRUE and outputs the same to the transformer target control state determining unit 120 based on the generator motor speed D10 and the control state of the transformer 26.

The transformer target control state determining unit 120 determines a new control state of the transformer 26 based on the transformer stop flag during deceleration F1, transformer start permission flag F2, and control state of the transformer 26. Further, the transformer control unit 130 outputs, to the transformer 26 the control state determined by the transformer target control state determining unit 120 as a control command.

At this point, the transformer target control state determining unit 120 shifts the control state of the transformer 26 based on the state transition diagram illustrated in FIG. 5. A preparation state ST0 is a state immediately after the key is turned ON or immediately after the key is turned OFF in which the contactor 27 is in a cut-off state while being energized. The transformer startup state ST1 is a state in which the transformer 26 is started, and current is input or output to or from the capacitor 25. The transformer stopped state ST2 is a state in which the transformer 26 is stopped while the contactor 27 is kept connected, and transform loss inside the transformer 26 and switching loss at a semiconductor device are prevented from occurring.

For example, in the cases where a present control state of the transformer target control state determining unit 120 is the transformer startup state ST1, and in the case where the transformer stop flag during deceleration F1 is TRUE, the state ST1 is shifted to the transformer stopped state ST2 to stop the transformer 26 (S1). Further, in the case where the present control state is the transformer stopped state ST2, and in the case where the transformer stop flag during deceleration F1 is FALSE and the transformer start permission flag F2 is TRUE, the state ST2 is shifted to the transformer startup state ST1 to start the transformer 26 (S2). Further, in the case where the present control state is the transformer stopped state ST2, and in the case where a hybrid system state D21 indicates a state of measuring estimated capacitance of the capacitor, the state ST2 is shifted to the transformer startup state ST1 to start the transformer 26 (S3).

Further, in the case where the present control state of the transformer target control state determining unit 120 is the transformer stopped state ST2, and in the case where the key is turned to the OFF state, the state ST2 is shifted to the preparation state ST0 to set the transformer 26 in the preparation state (S4).

Meanwhile, as illustrated in FIG. 5, the state between the preparation state ST0 and the transformer startup state ST1 is suitably shifted. For example, in the case where the present control state is the transformer startup state ST1, in the case where the transformer start permission flag F2 is FALSE, and in the case where the key is turned to the OFF state and the like, the state ST1 is shifted to the preparation state ST0 to set the transformer 26 in the preparation state same as S4. Further, in the case where the present control state is in the preparation state ST0, and in the case where the transformer start permission flag F2 is TRUE or the like, the state ST0 is shifted to the transformer startup state ST1 to start the transformer 26.

(Details of Transformer Stop Flag Determining Unit during Deceleration)

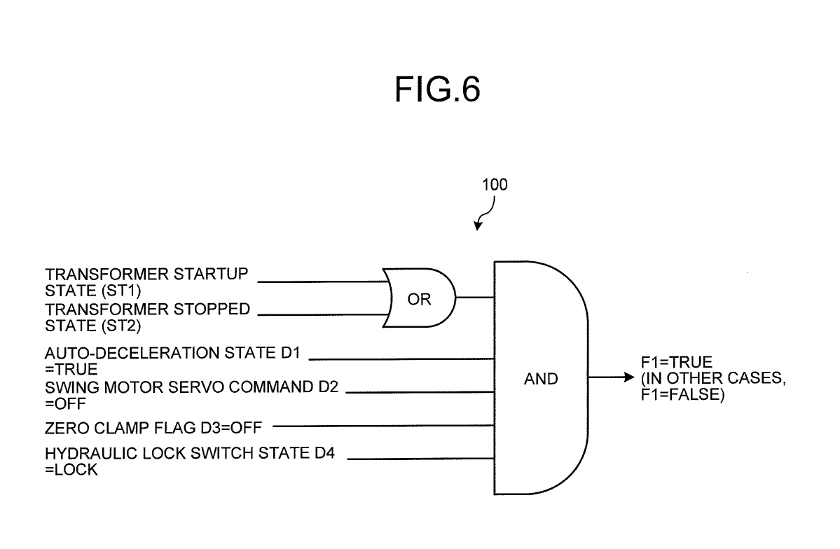

FIG. 6 is a diagram illustrating a detailed configuration of the transformer stop flag determining unit during deceleration 100. As illustrated in FIG. 6, the transformer stop flag determining unit during deceleration 100 outputs the transformer stop flag during deceleration F1=TRUE in the case where following five AND conditions are satisfied:

1) the control state of the transformer 26 is the transformer startup state ST1 or the transformer stopped state ST2;

2) the auto-deceleration state D1=TRUE;

3) the swing motor servo command D2=OFF;

4) the zero clamp flag D3=OFF; and

5) the hydraulic lock switch state D4=lock.

In the case where these five AND conditions are not satisfied, the transformer stop flag during deceleration F1=FALSE is output.

The reason for setting these five AND conditions is that all of these conditions are the states in which the transformer 26 is not necessarily used. In other words, these conditions are the states in which the swing motor 23 is not driven. Further, in the case where one of these conditions is not satisfied, for example, the swing motor servo command D2 becomes the ON state, the transformer stop flag during deceleration F1 is output as FALSE, determining that there is the intention to drive the swing motor 23.

Note that the conditions are not limited to these five AND conditions, and the number of the conditions may be reduced as well. For example, following three AND conditions may be adopted:

1) the control state of the transformer 26 is the transformer startup state ST1 or the transformer stopped state ST2;

2) the auto-deceleration state D1=TRUE; and

3) the swing motor servo command D2=OFF, or following three AND conditions may be adopted:

1) the control state of the transformer 26 is the transformer startup state ST1 or the transformer stopped state ST2;

2) the auto-deceleration state D1=TRUE; and

3) the hydraulic lock switch state D4=lock. Or, following four AND conditions may be adopted:

1) the control state of the transformer 26 is the transformer startup state ST1 or the transformer stopped state ST2;

2) the auto-deceleration state D1=TRUE;

3) the swing motor servo command D2=OFF; and

4) hydraulic lock switch state D4=lock.

Further, in the case where the state is shifted from the transformer stopped state ST2 to the transformer startup state ST1, the transformer stop flag during deceleration F1 is needed to be FALSE. However, in this case, the condition of the hydraulic lock switch state D4 is preferably changed to the condition of the transformer stop flag during deceleration F1=TRUE, considering a warm-up time after energizing the transformer 26. In other words, in the case of using the hydraulic lock switch 58, the warm-up time after energizing the transformer 26 can be recovered by the time required to operate the hydraulic lock switch 58, and no sense of discomfort is operationally given to the operator.

Thus, power supply from the capacitor 25 to the swing motor 23 can be cut off without shifting the contactor 27 to the cut-off state while the transformer is stopped. In the case of stopping the transformer, it is necessary to stop power supply from the capacitor 25. However, increasing frequency to stop the transformer increases the number of times to cut off the contactor 27, thereby shortening lifetime of the contactor 27. According to the transformer stop described in the present embodiment, energization can be cut off by the switching device. Therefore, power supply from the capacitor 25 can be cut off without cutting off the contactor 27. With this configuration, shortening lifetime of the contactor 27 can be prevented.

(Details of Transformer Start Permission Flag Determining Unit)

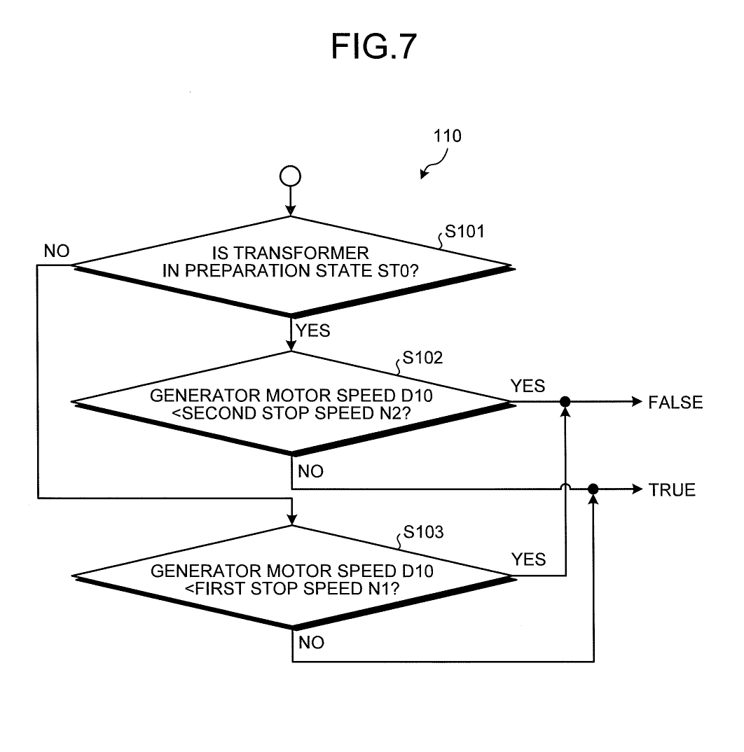

FIG. 7 is a flowchart illustrating detailed processing of the transformer start permission flag determining unit 110. As illustrated in FIG. 7, the transformer start permission flag determining unit 110 first determines whether the control state of the transformer 26 is the preparation state ST0 (Step S101).

In the case where the control state of the transformer 26 is the preparation state ST0 (Step S101, Yes), whether the generator motor speed D10 is less than a second stop speed N2 (800 rpm, for example) is determined (Step S102). Further, in the case where the generator motor speed D10 is less than the second stop speed N2 (800 rpm, for example) (Step S102, Yes), the transformer start permission flag F2 is output as FALSE. On the other hand, in the case where the generator motor speed D10 is not less than the second stop speed N2 (800 rpm, for example) (Step S102, No), the transformer start permission flag F2 is output as TRUE.

Further, in the case where the control state of the transformer 26 is not the preparation state ST0 (Step S101, No), whether the generator motor speed D10 is less than a first stop speed N1 (300 rpm, for example) is determined (Step S103). In the where the generator motor speed D10 is less than the first stop speed N1 (300 rpm, for example) (Step S103, Yes), the transformer start permission flag F2 is output as FALSE. On the other hand, in the where the generator motor speed D10 is not less than the first stop speed N1 (300 rpm, for example) (Step S103, No), the transformer start permission flag F2 is output as TRUE.

More specifically, a threshold of the generator motor speed D10 to output the transformer start permission flag F2 as TRUE is changed in accordance with a charge state of the transformer 26. More specifically, in the case where the control state of the transformer 26 is the preparation state ST0, the charge state is determined as a good state, and the threshold of the generator motor speed D10 is set at the high second stop speed N2 (800 rpm, for example). As a result, the transformer start permission flag F2 is prevented from being output as TRUE in the case where the generator motor speed D10 is, for example, 600 rpm. On the other hand, in the case where the control state of the transformer 26 is not the preparation state ST0 and is the transformer stopped state ST2, for example, the charge state is determined no good, and the threshold of the generator motor speed D10 is set at the low and high first stop speed N1 (300 rpm, for example). As a result, the transformer start permission flag F2 is output as TRUE in the case where the generator motor speed D10 is, for example, 600 rpm.

(Determining Processing for Auto-Deceleration State D1)

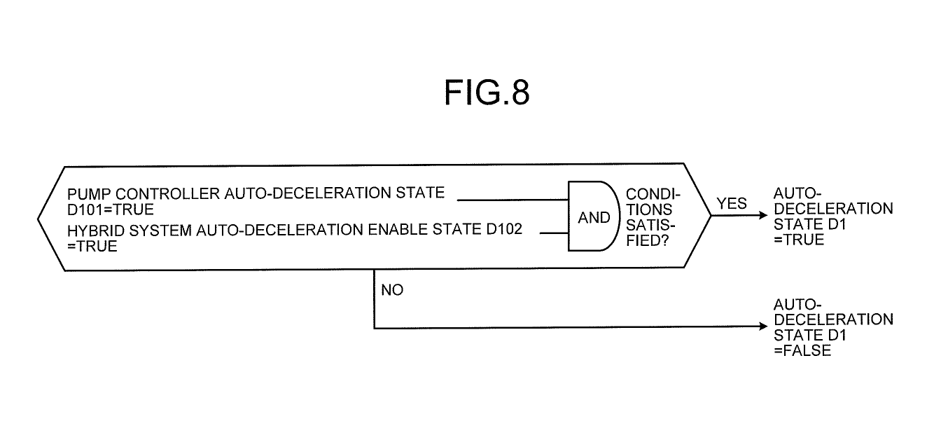

For the auto-deceleration state D1 used to determine the transformer stop flag during deceleration F1 illustrated in FIG. 6, an auto-deceleration state D101 of the pump controller C11, and an auto-deceleration enable state D102 of the hybrid system (hybrid controller C2) are used as illustrated in FIG. 8. In FIG. 8, in the case where the auto-deceleration state D101 is TRUE and the auto-deceleration enable state D102 is TRUE, the auto-deceleration state D1 is output as TRUE. In other cases, the auto-deceleration state D1 is output as FALSE.

(Determining Processing for Auto-Deceleration State D101 of Pump Controller C11)

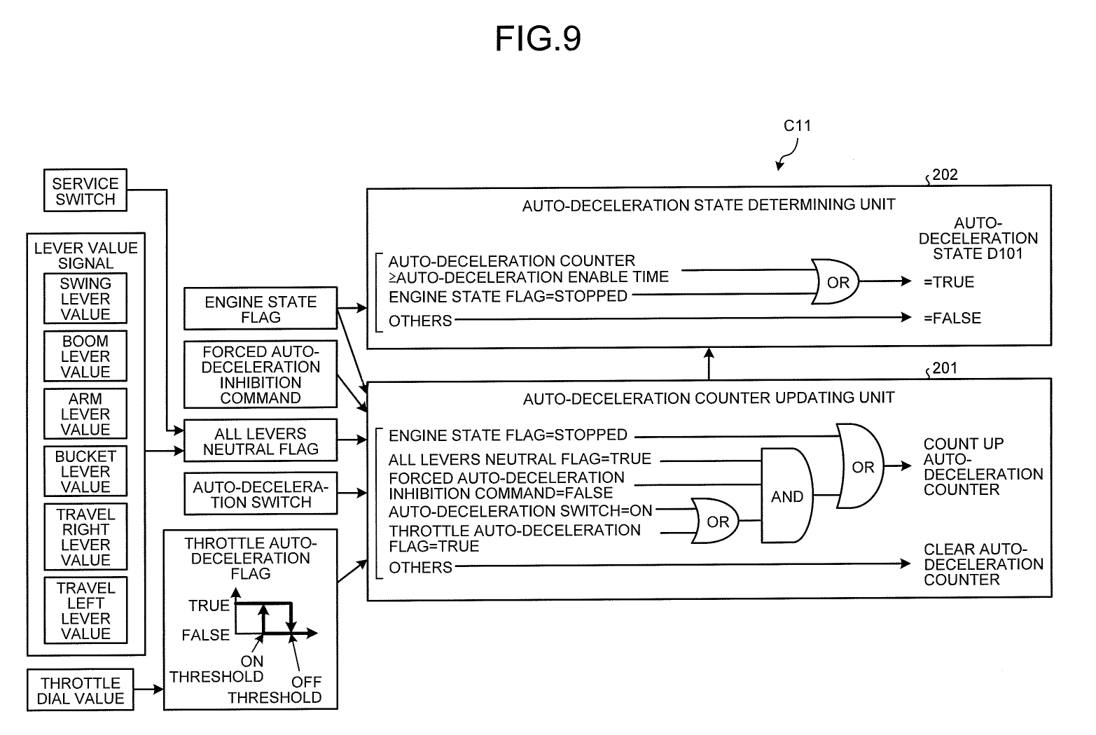

As illustrated in FIG. 9, the pump controller C11 includes an auto-deceleration counter updating unit 201, and an auto-deceleration state determining unit 202. In the auto-deceleration counter updating unit 201, an engine state flag transmitted from the engine controller C12, a forced auto-deceleration inhibition command transmitted from the hybrid controller C2, all levers neutral flag, an auto-deceleration switch transmitted from the monitoring device 30, and a throttle auto-deceleration flag are received. The all levers neutral flag is set to TRUE in the case where value of the all levers are neutral based on a lever value signal obtained from a swing lever value, a boom lever value, an arm lever value, a bucket lever value, a travel right lever value, and a travel left lever value, and also based on a signal obtained from a service switch. The throttle auto-deceleration flag is set to TRUE in the case where a throttle dial value becomes an ON threshold or less due to hysteresis processing, and the flag is set to FALSE in the case where the throttle dial value becomes an OFF threshold or more. The flag is set to TRUE when the throttle dial value is, for example, 25% or less of a maximum value. Note that a TRUE state of the forced auto-deceleration inhibition command indicates, for example, a state of measuring the capacitance of the capacitor.

The auto-deceleration counter updating unit 201 counts up the auto-deceleration counter in the case where the auto-deceleration switch is ON or the throttle auto-deceleration all levers neutral flag is TRUE, and the all levers neutral flag is TRUE; and in the case where the forced auto-deceleration inhibition command is FALSE; or in the case where the engine state flag is stopped. On the other hand, in the case of not satisfying the above conditions, the present auto-deceleration counter is cleared. Further, the auto-deceleration counter updating unit 201 outputs the updated auto-deceleration counter to the auto-deceleration state determining unit 202.

In the auto-deceleration state determining unit 202, the engine state flag and the auto-deceleration counter are received. Further, the auto-deceleration state determining unit 202 outputs the auto-deceleration state D101 of the pump controller C11 to the hybrid controller C2 as TRUE in the case where a value of the auto-deceleration counter is equal to or more than an auto-deceleration enable time or in the case where the engine state flag is stopped.

(Determining Processing for Auto-Deceleration Enable State D102 of Hybrid System)

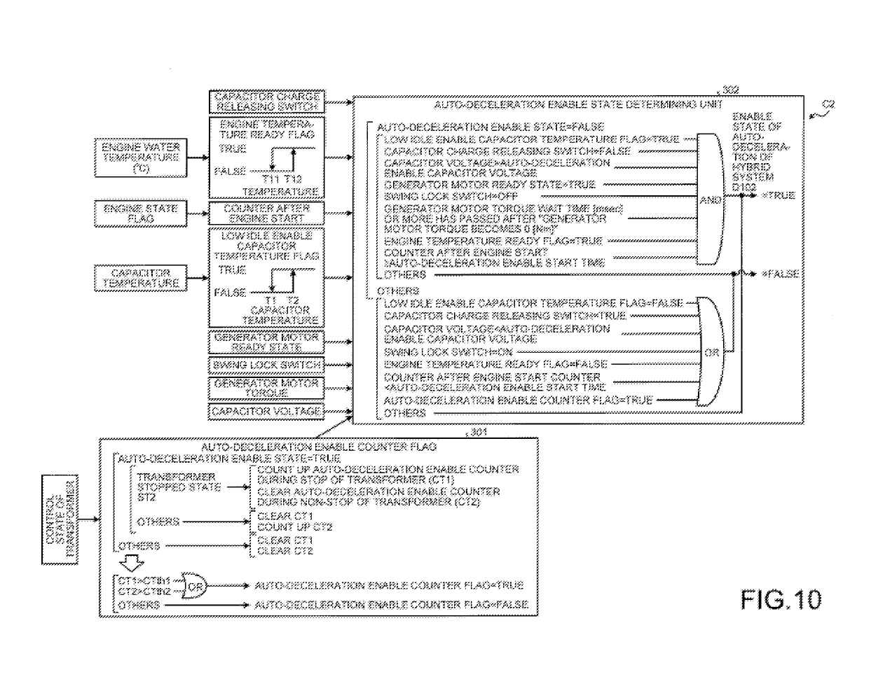

As illustrated in FIG. 10, the hybrid controller C2 includes an auto-deceleration enable counter flag 301, and an auto-deceleration enable state determining unit 302. In the auto-deceleration enable state determining unit 302, a capacitor charge releasing switch, an engine temperature ready flag, a counter after engine start, a low idle enable capacitor temperature flag, a generator motor ready state, a swing lock switch, a generator motor torque, a capacitor voltage, and an auto-deceleration enable counter flag 301 are received.

The capacitor charge releasing switch is transmitted from the monitoring device 30. Due to the hysteresis processing and based on the engine water temperature, in the case where the engine water temperature is T12 or higher, the engine temperature ready flag becomes TRUE, and in the case where the engine water temperature becomes t11 or lower, the engine temperature ready flag becomes FALSE. The counter after engine start counts a continuous stop period after engine start based on the engine state flag. Due to the hysteresis processing and based on the capacitor temperature, in the case where the capacitor temperature is T2 or higher, the low idle enable capacitor temperature flag becomes TRUE, and in the case where the capacitor temperature is T1 or lower, the low idle enable capacitor temperature flag becomes FALSE.

The auto-deceleration enable counter flag 301 counts, based on the control state of the transformer 26, an auto-deceleration enable counter during stop of transformer CT1 and an auto-deceleration enable counter during non-stop of transformer CT2. According to this count, in the case where the auto-deceleration enable state is TRUE at first and the control state of the transformer 26 is in the transformer stopped state ST2, the auto-deceleration enable counter during stop of transformer CT1 is counted up and the auto-deceleration enable counter during non-stop of transformer CT2 is cleared. Further, in the case where the auto-deceleration enable state is TRUE and the control state of the transformer 26 is not the transformer stopped state ST2, the auto-deceleration enable counter during stop of transformer CT1 is cleared and the auto-deceleration enable counter during non-stop of transformer CT2 is counted up. On the other hand, in the case where the auto-deceleration enable state is not TRUE, the auto-deceleration enable counter during stop of transformer CT1 and the auto-deceleration enable counter during non-stop of transformer CT2 are cleared.

Further, in the case where the auto-deceleration enable counter during stop of transformer CT1 that has been counted as described above exceeds a first count threshold CTth1, or in the case where the thus counted auto-deceleration enable counter during non-stop of transformer CT2 exceeds a second count threshold CTth2, the auto-deceleration enable counter flag is changed to TRUE. In other cases, the auto-deceleration enable counter flag is changed to FALSE.

In the case where the auto-deceleration enable state is FALSE, the auto-deceleration enable state determining unit 302 changes the auto-deceleration enable state D102 to TRUE on the following AND conditions that: low idle enable capacitor temperature flag is TRUE; the capacitor charge releasing switch is FALSE; the capacitor voltage exceeds auto-deceleration enable capacitor voltage; the generator motor ready state is TRUE; the swing lock switch is OFF; a generator motor torque wait time (Gen Trq Zero Wait Time=1000 msec) or more has passed after the generator motor torque becomes 0 [Nm]; the engine temperature ready flag is TRUE; and the counter after engine start is auto-deceleration enable start time or longer. In the case of not satisfying any one of the above conditions, the auto-deceleration enable state D102 is changed to FALSE and output as FALSE.

Further, in the case where the auto-deceleration enable state is not FALSE, the auto-deceleration enable state determining unit 302 changes the auto-deceleration enable state D102 to FALSE and output the same on the following OR conditions that: the low idle enable capacitor temperature flag is FALSE, the capacitor charge releasing switch is TRUE, the capacitor voltage is lower than auto-deceleration enable capacitor voltage, the swing lock switch is ON, the engine temperature ready flag is FALSE, the counter after engine start is shorter than the auto-deceleration enable start time, or the auto-deceleration enable counter flag is TRUE. In other cases, the auto-deceleration enable state D102 is changed to TRUE and output as TRUE.

According to the above-described embodiment, transformer stop flag during deceleration Fl is changed to TRUE to stop the transformer 26 in the case of satisfying a plurality of AND conditions including: the condition that the engine is in the auto-deceleration state D1 which is the low idle rotating state is TRUE; and aggravating condition that the engine is in the state corresponding to an operator's intention not to operate the upper swing body 5 or the work unit, such as the conditions that the swing motor servo command D2 corresponding to the swing lever operation is OFF, the zero clamp flag D3 is OFF, and the hydraulic lock switch state D4 is the lock state. Therefore, in the case of returning from the transformer stopped state, the transformer stop flag during deceleration F1 is changed to FALSE only by at least one of the above conditions being negated. At this point, the transformer 26 is started in accordance with the operator's intention, and therefore, the operator's operation intermediates. Therefore, a startup time of the transformer before the swing motor 23 will be able to be driven can be used up by the time generated before the operator executes operation. Therefore, there is no interruption in starting operation of the swing motor 23, and no sense of discomfort is given to the operator.

Meanwhile, in the case of stopping the transformer, a method to cut off the contactor 27 is applicable, but when the transformer is restarted, sparks may be produced by a voltage potential difference generated at the time of connection unless otherwise voltage around the contactor 27 is made uniform, and there may be a case where the contactor 27 is welded. Due to this, when the contactor 27 is connected, the voltage potential difference around the contactor 27 is needed to be made little. However, the transformer 26 is needed to be started in order to recover the voltage potential difference, and it takes time to start the transformer. In contrast, in the case where the transformer is stopped without cutting off the contactor 27 like the present embodiment, the startup time can be shortened. Further, lifetime of the contactor 27 is prolonged, and longer time use can be achieved.

Further, in the case of starting the transformer, the transformer start permission flag F2 is changed to TRUE based on the generator motor speed. However, electricity is to be charged immediately after recovery, and the generator motor speed may be decreased. Therefore, in such a case, the transformer start permission flag F2 can be changed to TRUE even though the generator motor speed is decreased.

Meanwhile, according to the above-described embodiment, in the case where the transformer stop flag during deceleration F1 is FALSE and the transformer start permission flag F2 is TRUE, the transformer can be returned from the transformer stopped state to the transformer startup state. However, the transformer may also be returned to the transformer startup state when the transformer stop flag during deceleration F1 is FALSE although fuel efficiency is slightly deteriorated compared to the above case.

### REFERENCE SIGNS LIST

1 Hybrid excavator
2 Vehicle body
3 Work unit
4 Lower traveling body
4a Travel device
4b Crawler
5 Upper swing body
6 Operating room
7 Fuel tank
8 Hydraulic oil tank
9 Engine room
10 Counterweight
11 Boom
12 Arm
13 Bucket
14 Boom hydraulic cylinder
15 Arm hydraulic cylinder
16 Bucket hydraulic cylinder
17 Engine
18a Swash plate
18 Hydraulic pump
19 Generator motor
20 Drive shaft
21 First inverter
22 Second inverter
23 Swing motor
24 Swing machinery
25 Capacitor
26 Transformer
27 Contactor
28 Voltage sensor
30 Monitoring device
31 Key switch
32 Operating lever
32R Right operating lever
32L Left operating lever
33 Operation valve
34 Right travel hydraulic motor
35 Left travel hydraulic motor
40 Fuel injector
41 Rotation sensor
50 Transformer temperature sensor
51 Capacitor temperature sensor
52 Ammeter
53 Voltage detection sensor
54, 54 Rotation sensor
56 Throttle dial
61 Pressure sensor
57 Swing lock switch
58 Hydraulic lock switch
100 Transformer stop flag determining unit during deceleration
110 Transformer start permission flag determining unit
120 Transformer target control state determining unit
130 Transformer control unit
201 Auto-deceleration counter updating unit
202 Auto-deceleration state determining unit
301 Auto-deceleration enable counter flag
302 Auto-deceleration enable state determining unit
C1 Other controllers
C11 Pump controller
C12 Engine controller
C2 Hybrid controller
D1 Auto-deceleration state
D10 Generator motor speed
D2 Swing motor servo command

D3 Zero clamp flag
D4 Hydraulic lock switch state
D20 Hybrid control state
D101 Auto-deceleration state
D102 Auto-deceleration enable state
F1 Transformer stop flag during deceleration
F2 Transformer start permission flag
ST0 Preparation state
ST1 Transformer startup state
ST2 Transformer startup state
SW1 Auto-deceleration switch

1. A hybrid work machine, comprising:
an engine;
a generator motor connected to an output shaft of the engine;
a storage battery configured to store power generated by the generator motor and supply power to the generator motor;
a motor configured to be driven by at least one of power generated by the generator motor and power stored in the storage battery;
a transformer disposed between the storage battery and both the generator motor and the motor; and
a control unit configured to stop the transformer at a time of satisfying a plurality of conditions including a condition that the engine is in an idling state and a condition that a motor driving command to drive the motor is not output.

2. A hybrid work machine, comprising:
an engine;
a generator motor connected to an output shaft of the engine;
a storage battery configured to store power generated by the generator motor and supply power to the generator motor;
a motor configured to be driven by at least one of power generated by the generator motor and power stored in the storage battery;
a transformer disposed between the storage battery and both the generator motor and the motor; and
a control unit configured to stop the transformer at a time of satisfying a plurality of conditions including a condition that the engine is in an idling state and a condition that a hydraulic lock switch is in a lock state.

3. A hybrid work machine, comprising:
an engine;
a generator motor connected to an output shaft of the engine;
a storage battery configured to store power generated by the generator motor and supply power to the generator motor;
a motor configured to be driven by at least one of power generated by the generator motor and power stored in the storage battery;
a transformer disposed between the storage battery and both the generator motor and the motor; and
a control unit configured to stop the transformer at a time of satisfying a plurality of conditions including a condition that the engine is in an idling state, a condition that a motor driving command to drive the motor is not output, and a condition that a hydraulic lock switch is in a lock state.

4. The hybrid work machine according to claim 1, wherein
the motor is a swing motor configured to swing a swing body, and the control unit is configured to stop the transformer in the case of satisfying a plurality of conditions added with a condition that a zero clamp is OFF.

5. The hybrid work machine according to claim 1, wherein
the control unit permits start of the transformer based on a generator motor speed.

6. The hybrid work machine according to claim 5, wherein
the control unit permits start of the transformer at a time of not satisfying at least of one of the plurality of conditions.

7. The hybrid work machine according to claim 1, wherein
the control unit stops the transformer by cutting off energization to the transformer while a contactor configured to execute connection and disconnection between the storage battery and the transformer is kept connected.

8. The hybrid work machine according to claim 2, wherein
the motor is a swing motor configured to swing a swing body, and the control unit is configured to stop the transformer in the case of satisfying a plurality of conditions added with a condition that a zero clamp is OFF.

9. The hybrid work machine according to claim 2, wherein
the control unit permits start of the transformer based on a generator motor speed.

10. The hybrid work machine according to claim 9, wherein
the control unit permits start of the transformer at a time of not satisfying at least of one of the plurality of conditions.

11. The hybrid work machine according to claim 2, wherein
the control unit stops the transformer by cutting off energization to the transformer while a contactor configured to execute connection and disconnection between the storage battery and the transformer is kept connected.

12. The hybrid work machine according to claim 3, wherein
the motor is a swing motor configured to swing a swing body, and the control unit is configured to stop the transformer in the case of satisfying a plurality of conditions added with a condition that a zero clamp is OFF.

13. The hybrid work machine according to claim 3, wherein
the control unit permits start of the transformer based on a generator motor speed.

14. The hybrid work machine according to claim 13, wherein
the control unit permits start of the transformer at a time of not satisfying at least of one of the plurality of conditions.

15. The hybrid work machine according to claim 3, wherein
the control unit stops the transformer by cutting off energization to the transformer while a contactor configured to execute connection and disconnection between the storage battery and the transformer is kept connected.
